(19) United States
(12) Patent Application Publication
(10) Pub. No.: US 2026/0072118 A1
(43) Pub. Date: Mar. 12, 2026

(54) AI-ASSISTED BLUETOOTH LOW ENERGY (BLE) CHANNEL SOUNDING PROCESSING

(71) Applicant: Cypress Semiconductor Corporation, San Jose, CA (US)

(72) Inventors: Avik Santra, Irvine, CA (US); Andrii Tsemko, Melitopol (UA); Oleg Kapshii, Lviv (UA); Ashutosh Pandey, Irvine, CA (US)

(73) Assignee: Cypress Semiconductor Corporation, San Jose, CA (US)

(21) Appl. No.: 19/052,841

(22) Filed: Feb. 13, 2025

Related U.S. Application Data
(60) Provisional application No. 63/692,585, filed on Sep. 9, 2024.

(51) Int. Cl. G01S 5/02; G01S 5/00; G06N 3/09; H04W 24/10

(52) U.S. Cl. CPC G01S 5/0205; G01S 5/012; G06N 3/09; H04W 24/10

(57) ABSTRACT

Techniques are described of a BLE CS processing architecture using a parametric data-driven neural network design for phase-based ranging (PBR). The neural network may integrate feature transformation and range estimation to simultaneously generate a clean spectrum and a range estimate. The neural network may receive PBR measurement data of constant tone signals across a range of frequencies exchanged between two devices. The neural network may extract from the PBR measurement data, features representative of non-integer frequencies across the range of frequencies. The non-integer frequencies may be sampled at non-fixed positions and in an ascending order. The neural network may estimate a distance between the two devices based on the features extracted. In one embodiment, the neural network may combine scene identification, de-noising, feature transformation and distance estimation steps into a single model. The neural network may adapt to various indoor or outdoor scenes without requiring an explicit scene identification step.

### CROSS REFERENCE TO RELATED APPLICATIONS

This application claims the benefit of the filing date of U.S. Provisional Application No. 63/692,585 filed on Sep. 9, 2024 by Applicant Cypress Semiconductor Corporation, the disclosure of which is incorporated herein by reference in its entirety.

### TECHNICAL FIELD

This disclosure generally relates to technologies for positioning and ranging using wireless signals, and more particularly, to artificial intelligence assisted (AI-assisted) phase-based ranging techniques for providing sub-meter accuracy and distance measurements for point-to-point wireless positioning and tracking applications using narrow-band radios such as Bluetooth technologies.

### BACKGROUND

Ranging and localization applications such as secured entry, indoor positioning, asset tracking, etc., are increasingly relying on the use of narrow-band radios such as Bluetooth Low Energy (BLE) or IEEE 802.15.4 to provide sub-meter accuracy and secure distance measurements. For example, smart tags, smart phones, smart devices, Internet-of-Things (IOT) that use short-range BLE technologies for wireless communication may use BLE radios to perform ranging and positioning of other devices. In one such technique, two devices may calculate their range (also referred to as distance) by exchanging unmodulated pulses (also known as “constant tones” in the literature) and measuring the amount of signal-phase shifts between them. To mitigate multi-path fading, the two devices may measure phase shifts over multiple frequencies to achieve an acceptable accuracy. However, it is difficult for phase-based ranging solutions using unmodulated pulses to achieve centimeter ranging accuracy in an indoor environment. In a complex and dynamic indoor environment, signal propagation path to a target may be constantly changing due to the motion of the target and geometries of the indoor space, leading to reflections, diffraction, and multipath interference of the constant tone signals. Indoor environments are also subject to high interference due to other wireless devices operating in the same frequency bands, such as WiFi. It is desired to improve the accuracy of phase-based ranging solutions in an indoor or other dynamically changing environment.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating a transmitting device transmitting unmodulated pulses to a receiving device for the receiving device to measure the phase of the received signal in a multi-carrier phase-based ranging (PBR) application, in accordance with one aspect of the present disclosure;

FIG. 2 is a signaling diagram illustrating an initiator device and a reflector device synchronizing timing and exchanging constant tone signals using Bluetooth LE channel sounding (CS) application, and for the initiator device to process phase data measured by both devices to estimate a range between the devices, in accordance with one aspect of the present disclosure;

FIG. 3 illustrates two devices exchanging unmodulated pulse signals across multiple channels and measuring the phase shifts for the devices to estimate their mutual range, in accordance with one aspect of the present disclosure;

FIG. 4 illustrates an initiator estimating the distance (also known as ranging) to a reflector based on phases measured by the initiator and the reflector for two frequency tones (e.g., channels), in accordance with one aspect of the present disclosure;

FIG. 5 illustrates a block diagram of a model-based CS processing pipeline that does not leverage a neural network and that is used by an initiator device of a phase-based ranging application to estimate the range to a reflector device, in accordance with one aspect of the present disclosure;

FIG. 6 illustrates a block diagram of a CS processing pipeline with a unified neural network for feature transformation and range estimation functionality, in accordance with one aspect of the present disclosure;

FIG. 7 illustrates a block diagram of a CS processing pipeline with a unified neural network for feature transformation and range estimation with de-noising functionality, in accordance with one aspect of the present disclosure;

FIG. 8 illustrates a block diagram of a CS processing pipeline 800 including another embodiment of the neural network for feature transformation and range estimation with de-noising functionality, in accordance with one aspect of the present disclosure;

FIG. 9 illustrates a block diagram of an embodiment of the feature selection module with adaptive filter in the CS processing pipeline of FIG. 8 used to adaptively adjust a bandwidth of a confidence-based bandpass filter for filtering the I/Q measurement data based on a confidence level in the data points and the identified scene, and to generate a covariance matrix based on the bandpass-filtered I/Q data in accordance with one aspect of the present disclosure;

FIG. 10 illustrates a flow diagram of a method of applying a neural network to phase-based ranging measurement data to perform feature transformation and range estimation of a distance between two devices, in accordance with one aspect of the present disclosure;

FIG. 11 illustrates a functional block diagram of two Bluetooth devices that implement phase-based ranging using CS and CS post-processor of the phase measurement data to estimate a range between the two devices using a neural network model, in accordance with one aspect of the present disclosure.

### DETAILED DESCRIPTION

Examples of various aspects and variations of the subject technology are described herein and illustrated in the accompanying drawings. The following description is not intended to limit the invention to these embodiments, but rather to enable a person skilled in the art to make and use this invention.

Described are systems and methods for using neural networks to improve the accuracy of phase-based ranging and tracking applications in an indoor or other dynamically changing environment based on Bluetooth Low Energy (BLE), IEEE 802.15.4, or other short-range narrow-band radio technologies. High-accuracy distance measurement and positioning applications may use multi-carrier phase-based ranging, referred to as multi-carrier phase difference (MCPD) (or channel sounding (CS) in BLE) techniques, in which the two-way phase difference between two devices is measured over multiple carriers. In phase-based ranging (PBR), the two devices, the initiator and the reflector, exchange multiple unmodulated pulses (UP) (also referred to as constant tones in BLE) over different carrier frequencies to mitigate multi-path fading and interference. The initiator is the device that initiates the ranging and the reflector is the device that responds to the initiator request. In applications using phase-based ranging, the initiator and the reflector may perform phase measurements on each other's UP. For example, the initiator may send the UP toward the reflector for the reflector to measure the phase of the received UP. In turn, the reflector may send back its own UP toward the initiator for the initiator to measure the phase of the received UP. At the end of the multiple UP exchanges, the initiator and the reflector may exchange their phase measurement results to estimate the range between the initiator and the reflector. In multi-carrier phase-based ranging operations, the ranging and positioning measurements may be repeated over multiple channels (carrier frequencies).

PBR applications using UP are prone to errors in an indoor or other dynamic changing environment. In such an environment, a target of the ranging application, such as people, furniture, and equipment may move or change, affecting signal propagation of the UP. An indoor environment may also have complex geometries, e.g., walls, corners, and other obstacles made of a myriad of materials, leading to reflections, diffractions, and multipath interference of signals. An indoor environment may also be teeming with other wireless devices operating in the same frequency bands as BLE, leading to channel interference.

Operations to estimate a target range may involve a multi-stage process. A pre-processing stage may calculate a residual phase term to remove arbitrary phase offsets from the phase measurement data, followed by zero distance calibration and gain normalization to compensate for antenna tolerances and timing delays. Subsequently, a scene identification step may operate on the residual phase term to classify the types of environment (e.g., indoor, outdoor) using techniques such as linear regression. Next, a generic filtering and smoothing step may be applied to denoise the signal to enhance the signal-to-noise ratio.

A feature transformation stage may operate on the pre-processed filtered data to transform the phase measurements from the frequency domain to the time domain using inverse fast Fourier transform (IFFT) or other finer-resolution algorithms to identify the earliest peak as the estimated target range. Alternatively, the estimation of the target range may involve determining a slope of the distribution of the phase measurements across the multiple channels (e.g., 72 1 MHz BLE data channels in the 2.4 GHz band) using a line-fit algorithm or linear regression technique. Based on the scene identified from the pre-processing stage, a range-estimation algorithm may detect the peak or 2 dB lower beamwidth peak in the transformed spectrum to report initial range estimates. A tracking stage using a Kalman filter may refine the initial range estimates utilizing a constant velocity model to estimate the final range estimate.

The IFFT or other digital frequency transform (DFT)-based feature transformation techniques are susceptible to noise such as multi-path reflections, RF interferences, and environmental changes during sequential measurements on different frequencies—conditions that are especially prevalent in an indoor environment. For example, the width of the peak using the IFFT technique may be too wide or the slope of the phase measurements using the line-fit algorithm may be too noisy to yield the desired range accuracy in high-accuracy positioning (HAP) applications. These techniques also do not handle out of distribution phase measurements or other anomalies attributed to the indoor environment.

Techniques described herein introduce a BLE CS processing architecture that uses a parametric data-driven neural network design, leveraging the strength of both data-driven and model-based approaches. The neural network architecture combines techniques that retain the interpretable design of traditional model-based pipeline leveraging domain knowledge. The neural network architecture learns to optimize range estimation directly from raw channel sounding data, leading to improved accuracy while reducing computational complexity for range estimation in BLE CS applications.

In one aspect, the neural network achieves both feature transformation and range estimation by integrating both of these steps. The neural network may be trained with a multi-task learning framework to simultaneously generate a clean spectrum and a range estimate. Unlike DFT-based techniques, where frequencies are fixed and equi-spaced, the learned features of the neural network may discover frequencies that are non-integer, sampled at non-fixed positions, and in an ascending order to enhance feature extraction from the phase measurements.

In one aspect, the neural network combines scene identification, de-noising, feature transformation and range estimation steps into a single neural network. By combining these steps into a single neural network, the neural network may adapt to various scene types or environments without requiring an explicit scene identification step. In one aspect, the neural network may employ an auxiliary loss function in conjunction with a main loss function during training. The main loss function may be calculated as the mean squared error between estimated and true distances. The auxiliary loss function may compare the estimated spectrum of a feature transformation layer of the neural network with an artificially generated spectrum of the environment featuring only a dominant peak. For example, based on the known distance of a target, ideal phase characteristics may be processed using IFFT to generate the expected spectrum output. The auxiliary loss function may be calculated as the mean squared error between the expected and estimated spectra. The training process may incorporate the two hyperparameters representing the weights of the main and auxiliary losses, enabling a balance optimization of both objectives.

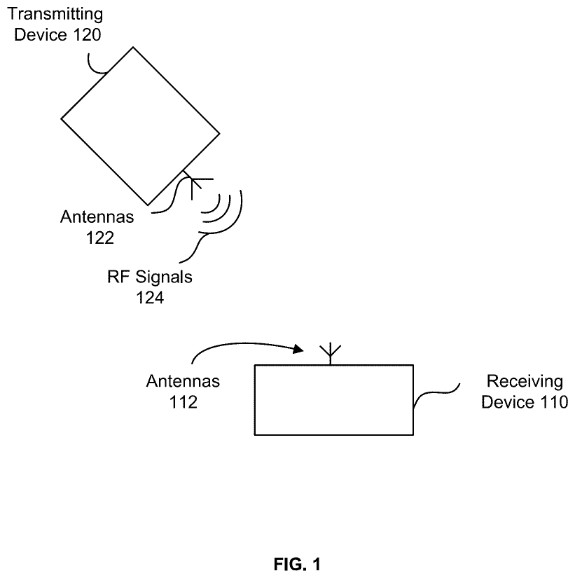

FIG. 1 is a block diagram illustrating a transmitting device transmitting unmodulated pulses (also referred to as constant tones) to a receiving device for the receiving device to measure the phase of the received signal in multi-carrier PBR, in accordance with one aspect of the present disclosure. The transmitting device 120 is shown to transmit through an antenna 122 unmodulated pulse RF signals 124 over multiple carrier frequencies. The receiving device 110 is coupled to an antennas 112 to receive the RF signals 124 to measure the phase of the received signals. The transmitting device 120 may be an initiator and the receiving device 110 may be a reflector. Conversely, the transmitting device 120 may be a reflector and the receiving device 110 may be an initiator. The reflector may be the target whose distance or range to the initiator is to be determined.

The transmitting device 120 may include circuitry to not only transmit RF signals but also to receive RF signals. Conversely, the receiving device 110 may include circuitry to not only receive RF signals but also to transmit RF signals. A phase-based ranging cycle may include multiple time-slots used by the two devices to exchange unmodulated pulses at different channels (e.g., different carrier frequencies) to estimate the distance. Each time-slot may include a receiving time interval during which a device receives an unmodulated pulse signal from the other device to measure its phase and a transmission time interval during which the first device transmits an unmodulated pulse signal for phase measurements by the other device. In each time-slot, the two devices 110 and 120 may exchange the unmodulated pulses in a different channel from the previous or the next time-slot.

The devices 110 and 120 may be connected as part of a Wireless Personal Area Network (WPAN), a Wireless Local Area Network (WLAN), or any other wireless networks. Communication protocols supported by the devices 110 and 120 may include, without limitation, Bluetooth (e.g., BLE), ZigBee, or Wi-Fi having frequencies in the Industrial, Scientific, and Medical (ISM) band. In one embodiment, the two devices may exchange 72 unmodulated pulse signals across the 80 MHz of the entire 2.4 GHz ISM band in BLE. In one embodiment, the ISM band may be at the millimeter-wave frequency such as the 60 GHz band to increase the channel bandwidth.

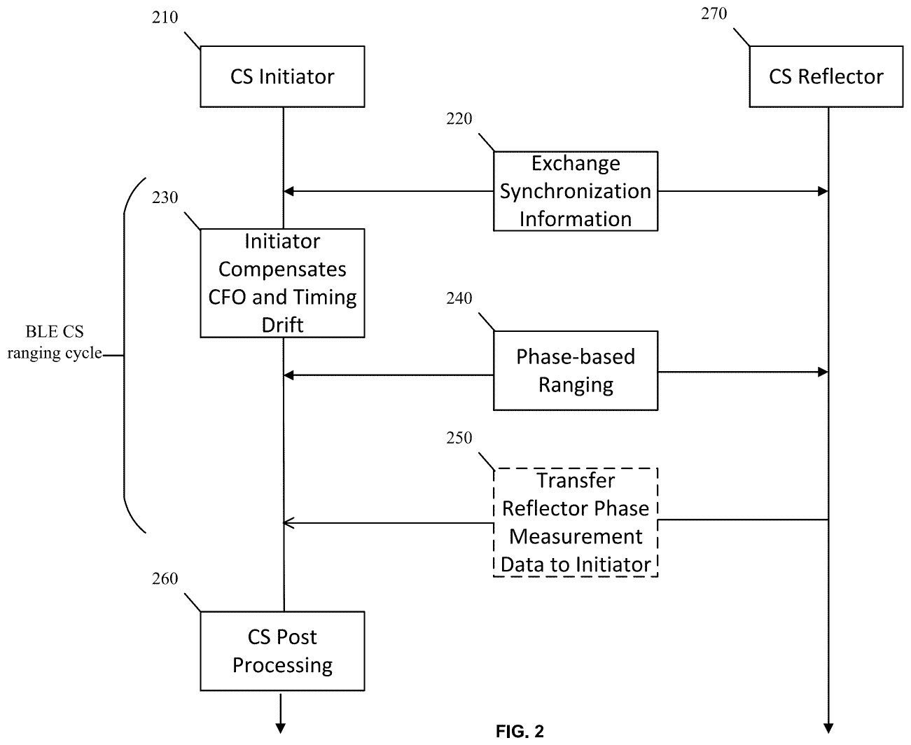

FIG. 2 is a signaling diagram illustrating an initiator device and a reflector device synchronizing timing and exchanging constant tone signals in Bluetooth LE CS application, and for the initiator device to process phase data measured by both devices to estimate a range between the devices, in accordance with one aspect of the present disclosure. A CS initiator 210 starts the BLE CS raging cycle with a CS reflector 270. The two devices exchanges constant tone signals over multiple channels to determine a wideband frequency domain transfer function of the channel.

Each ranging cycle may be divided into multiple timeslots. At the beginning of the BLE CS ranging cycle, in a calibration-synchronization timeslot, CS initiator 210 and CS reflector 270 may measure their frequency error offsets and may exchange synchronization information at operation 220 to synchronize their timing. CS initiator 210 may compensate for frequency offset and timing drift relative to CS reflector 270 at operation 230 based on the synchronization information. After the devices are time synchronized, a BLE host may schedule the devices to perform the constant tone (CT) exchanges in subsequent timeslots. At the beginning of each subsequent timeslot, the devices may switch to a new channel that will be used for performing the CT exchanges in the timeslot. The CT exchanges on N channels using N respective timeslots may be designated as the phase-based ranging operation 240.

For example, at a first timeslot for the CT exchange, CS initiator 210 may transmit a CT signal to CS reflector 270 on a first channel f₁. CS reflector 270 may perform phase (or I/Q) measurement on the received CT signal. The phase measurement may depend on the distance between CS initiator 210 and the CS reflector 270, and the phase difference between the reflector's local oscillator (LO) used to receive the UP signal and the initiator's LO used to transmit the UP signal. CS reflector 270 may measure a phase of Φ_{Ref}. Following this, CS reflector 270 may transmit back a CT signal to CS initiator 210 on the same channel f₁ so that CS initiator 210 may perform its phase measurement. CS initiator 210 may measure a phase of Φ_{Ini} on its received CT signal. At the end of the ranging cycle following the N timeslots for CT exchanges, CS reflector 270 may transmit its measured phase Φ_{Ref} to initiator 210 at operation 250. CS initiator 210 initiator may sum its measured phase Φ_{Ini} with the phase Φ_{Ref} measured by CS reflector 270 to generate Φ₁, which may represent the phase difference experienced by the CT signal of channel f₁ after traversing twice the distance between CS initiator 210 and CS reflector 270. In one embodiment, CS initiator 210 and CS reflector 270 can measure the input signal phase of a received CT signal in hardware and can control the output signal phase of a transmitted CT signal, referred to as inline phase correction. In such cases, CS initiator 210 and CS reflector 270 can correct their phase ambiguity automatically in hardware because the phase ambiguity will be in multiples of 2π. As such, CS reflector 270 does not transmit its measured phase Φ_{Ref} to CS initiator 210 at operation 250. CS initiator 210 directly measures the I/Q of the received CT signal to estimate the range.

At a second timeslot, CS initiator 210 and CS reflector 270 may exchange CT signals on a second channel f₂. CS reflector 270 and CS initiator 210 may respectively measure a phase on the received CT signal on channel f₂. CS reflector 270 may transmit its measured phase to CS initiator 210 at operation 250 for CS initiator 210 to sum its measured phase with the phase measured by CS reflector 270 to generate Φ₂, which may represent the phase difference experienced by the CT signal of channel f₂ after traversing twice the distance between CS initiator 210 and CS reflector 270. Similarly, at a third timeslot, CS initiator 210 and CS reflector 270 may exchange CT signals on a third channel f₃. The resulting phase difference Φ₃ may represent the phase difference experienced by the CT signal of channel f₃ after traversing twice the distance between CS initiator 210 and CS reflector 270.

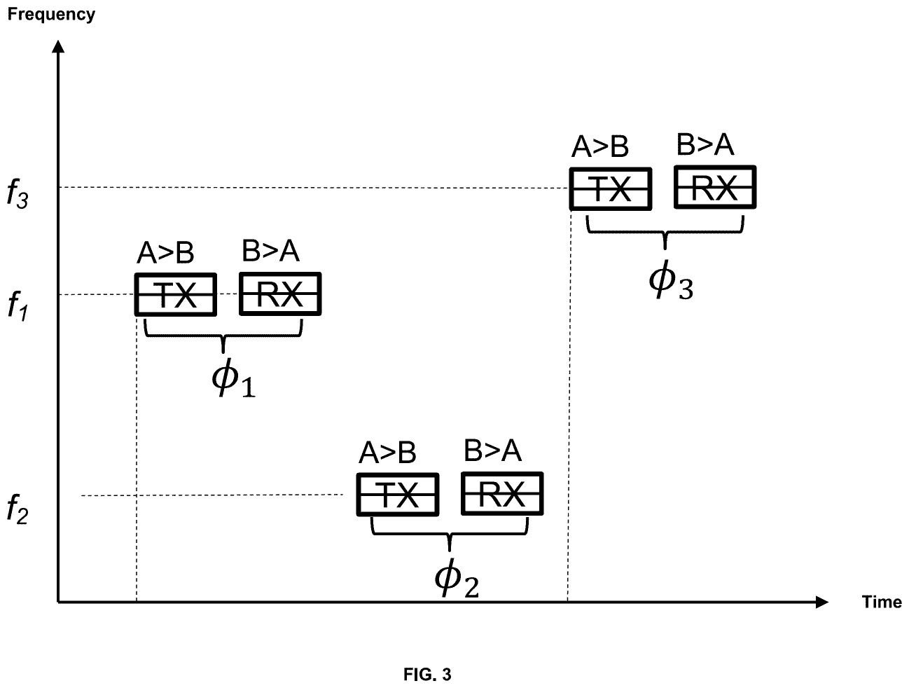

FIG. 3 illustrates two devices exchanging unmodulated pulse signals across multiple channels and measuring the phase shifts for the devices to estimate their mutual range, in accordance with one aspect of the present disclosure. Φ₁, Φ₂, and Φ₃ may represent the phase difference experienced by the CT signal of channel f₁, f₂, and f₃, respectively, after traversing twice the distance between CS initiator 210 and CS reflector 270.

Returning to FIG. 2, a CT signal on a channel k transmitted by CS initiator 210 and received by CS reflector 270 may be expressed as:

$$i {q}_{R}^{k} = {α}_{R}^{k} exp ( j ( - \frac{2 π {f}^{k} D}{c} + {φ}_{I}^{k} - {φ}_{R}^{k} ) ) \qquad ( Equation 1 )$$

where

$$i {q}_{R}^{k}$$

is the I/Q signal (in-phase and quadrature components of complex envelope of the RF signal) measured by CS reflector 270 (e.g., phase of

$$i {q}_{R}^{k}$$

is also designated Φ_{Ref} above);
D is the distance between CS initiator 210 and the CS reflector 270;
c is the wave propagation speed;
f^{k} is the RF frequency of channel k;

$${φ}_{I}^{k}$$

is the phase ambiguity of CS initiator 210;

$${φ}_{R}^{k}$$

is the phase ambiguity of CS reflector 270; and

$${α}_{R}^{k}$$

is the magnitude of

$$i {q}_{R}^{k} .$$

A CT signal transmitted by CS reflector 270 and received by CS initiator 210 on the same channel k may be expressed as:

$$i {q}_{I}^{k} = {α}_{I}^{k} exp ( j ( - \frac{2 π {f}^{{k}_{D}}}{c} + {φ}_{R}^{k} - {φ}_{I}^{k} ) ) \qquad ( Equation 2 )$$

where

$$i {q}_{I}^{k}$$

is the IQ signal measured by CS initiator 210 (e.g., phase of

$$i {q}_{I}^{k}$$

is also desiginated Φ_{Ini} above); and

$${α}_{I}^{k}$$

is the magnitude of

$$i {q}_{I}^{k} .$$

CS initiator 210 may combine

$${iq}_{R}^{k} with {iq}_{I}^{k}$$

to remove the phase ambiguities:

$$i {q}^{k} = i {q}_{I}^{k} * i {q}_{R}^{k} = {β}^{k} exp ( j ( - \frac{4 π {f}^{{k}_{D}}}{c} ) ) \qquad ( Equation 3 )$$

where
iq^{k} represents the change in the CT signal on channel k after traversing twice the distance D between CS initiator 210 and the CS reflector 270; and
β^{k} is the magnitude of iq^{k}.

Equation 3 has a half-wave ambiguity. To resolve the half-wavelength ambiguity, the changes in the CT signal may be measured at two distinct frequencies:

$$Δφ [ k ] = \frac{4 π Δ f [ k ] D}{c} ( mod 2 π ) \qquad ( Equation 4 )$$

where
ΔΦ[k] is the change in phase between the two frequencies; and
Δf is the difference between the two frequencies.

A CS post processing operation 260 may estimate distance D using the IQ measurements (Δiq[k]) from a few frequencies:

$$D = - \frac{c Δ φ [ k ]}{4 πΔ f [ k ]} ( mod \frac{c}{2 Δ f [ k ]} ) \qquad ( Equation 5 )$$

Alternatively, CS post processing operation 260 may estimate distance D using the entire set of measurements from one ranging cycle, such as averaging over the changes in I/Q measured between pairs of frequencies over all the narrow channels in Bluetooth LE (e.g., K_{f}=72):

$$D = \frac{c}{4 π Δ f [ k ]} \frac{1}{{K}_{f} - 1} {\sum }_{k = 1}^{{K}_{f} - 1} Δφ [ k ] ( mod \frac{c}{2 Δ f} ) \qquad ( Equation 6 )$$

Thus, the bandwidth may be effectively increased by a factor of 72 without reducing the range ambiguity. As a result, the range estimate may be less sensitive to phase errors.

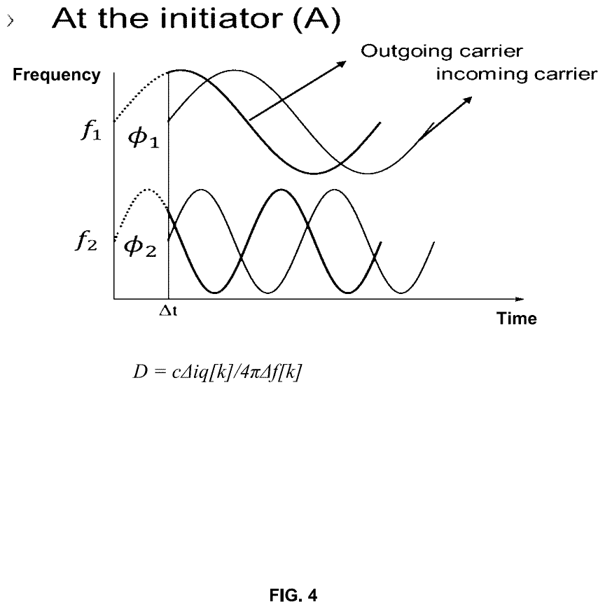

FIG. 4 illustrates CS initiator 210 estimating the distance to CS reflector 270 based on phases measured by CS initiator 210 and CS reflector 270 for two channels f¹ and f² in accordance with one aspect of the present disclosure.

Φ₁, and Φ₂ may represent the phase difference experienced by the CT signal of channel f¹ and f², respectively, after traversing twice the distance between CS initiator 210 and CS reflector 270. The distance D is estimated based on Equation 5 where Δiq[k] is the changes in I/Q between Φ₁, and Φ₂, and Δf[k] is the frequency difference between f¹ and f².

As mentioned, PBR applications using CT signals are prone to errors in an indoor or other dynamic changing environment due to target movement, changing signal propagation path, complex geometries, multipath, channel interference, etc. Disclosed are techniques to process phase measurement data using a parametric data-driven neural network, leveraging the strength of both data-driven and model-based approaches to improve the accuracy of PBR and tracking application in an dynamic indoor or other complex environment. The disclosed techniques are able to learn patterns to adapt to various environments to estimate a target range from channel sounding data. Embodiments of the techniques use BLE CS to illustrate its operation, but it may also be applied to other types of narrowband radios implementing PBR.

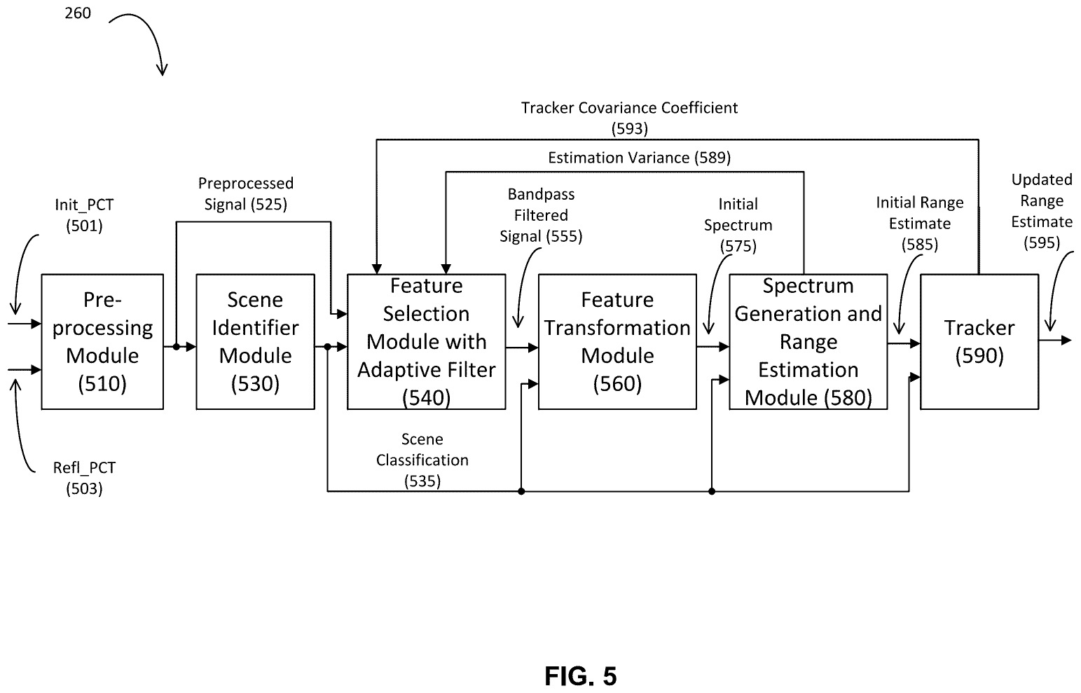

FIG. 5 illustrates a block diagram of a model-based processing pipeline that does not leverage a neural network and that is used by an initiator device of a phase-based ranging application to estimate the range to a reflector device, in accordance with one aspect of the present disclosure. The processing pipeline may be part of the CS post processing operation 260 of FIG. 2.

A preprocessing module 510 may preprocess I/Q data measured by the initiator device (or simply initiator) and reflector device (or simply reflector) during the CT exchanges on multiple channels to reduce artifacts introduced by the CT exchanges and other errors and/or interference in the data. The I/Q measurement data from the initiator and reflector may be designated Init_PCT (Initiator_Phase_Correction_Term) 501 and Refl_PCT (Reflector_Phase_Correction_Term) 503, respectively. In one embodiment, the Init_PCT 501 and Refl_PCT 503 may be divided into frames, with each frame representing the I/Q data measured over a ranging cycle of N timeslots for CT exchanges over N channels.

Pre-processing module 510 may remove errors and ambiguities in the I/Q measurement data prior to using the data for range estimation. For example, pre-processing module 510 may be configured to normalize Init_PCT 501 and Refl_PCT 503 using PCT calibration values obtained from a calibration stage to negate errors introduced by the antennas and any analog front-end (AFE) effects of the initiator and reflector. Pre-processing module 510 may be further configured to correct for changes in the amplification of the CT signals when the initiator or reflector collects the I/Q data at different ranging cycles of the multi-channel CT exchanges. Pre-processing module 510 may also be configured to correct for phase ambiguity in the I/Q measurement data due to Doppler frequency, co-channel interference, and two-sided communication of the CT exchanges.

A scene identification module 530 may process statistical properties of preprocessed signal 525 from pre-processed module 510 to identify the scene (e.g., indoor with dynamic variation, indoor with low variation, outdoor, etc.). In one example, scene identification module 530 may identify a scene based on empirical observations or domain knowledge of the statistical properties associated with different scene types (i.e., indoor vs. outdoor scene). The identified scene, scene classification 535, may be used to set the processing pipeline. For example, algorithmic parameters of the processing pipeline may be tuned or optimized based on the identified scene to improve the accuracy of PBR in an indoor environment.

A feature selection module with adaptive filter 540 may adaptively adjust a bandwidth of a bandpass filter used to filter preprocessed signal 525 based on a level of confidence associated with the data points and scene classification 535. For example, when scene classification 535 indicates an indoor scene, the bandwidth of the bandpass filter may be modulated by a confidence estimate, such as the signal-to-noise ratio (SNR) of the data points. In one embodiment, the confidence estimate may be uncertainty in the measurement techniques such as a tracker covariance coefficient 593 from a tracker module 590. In one embodiment, tracker covariance coefficient 593 may be the covariance matrix representing uncertainty in the state estimate from a Kalman filter. Higher values in the elements of the covariance matrix may indicate lower confidence in the range estimate. In one embodiment, the confidence estimate may be other variability measure of the data points such as the mean square error (MSE), local standard deviation, standard deviation of local means, mean of local standard deviation, etc., calculated by scene identifier module 530. In one embodiment, the confidence estimate may be an estimation variance 589 of range estimates from a spectrum generation and range estimation module 580.

The confidence-based bandpass filter may allow frequency components within a desired range to pass through while attenuating other. For example, for data points with high confidence, the bandpass filter operates with a narrower bandwidth to allow a smaller range of frequencies around the expected signal to pass through. The narrower bandwidth focuses on the most likely signal components and reduces the influence of out-of-band interference, reflections, or noise to improve the accuracy of the estimated range as confidence increases. For data points with low confidence, the bandpass filter operates with a wider bandwidth to reduce the influence of potentially unreliable filtering on the final estimates. The wider bandwidth captures a potential change in the true signal (e.g., target moved) to prevent the filter from attenuating the new desired signal components.

A feature transformation module 560 may implement a DFT-based algorithm such as IFFT or a minimum variance distortion-less response (MVDR) algorithm to transform bandpass filtered signal 555 generated by feature selection module with adaptive filter 540 from the frequency domain to the time domain as a function of the identified scene. The MVDR-based technique may generate a narrower peak in the time domain than an IFFT-based technique, allowing for finer resolution of multipath components to detect the target as the closest peak.

A spectrum generation and range estimation module 580 may process initial spectrum 575 generated by the feature transformation module 560 to generate parallel moving average spectrum for range estimation and faster Kalman filter estimate convergence. Multiple moving average spectrums, each one with a different smoothing factor, may generate smoothed spectral trends for range estimation. The smoothing factors may be adaptive to the identified scene, so a moving average spectrum may adapt faster to changes in the spectral trend for an indoor scene with dynamic variation. A range estimation algorithm may operate on each of the multiple moving average spectrum to estimate the respective range as a corresponding closest peak (e.g., earliest peak). The range estimation algorithm may store range indices for one or more candidate peaks. The candidate peaks may represent signal peaks of a direct path component or multipath components. For example, a candidate peak with the smallest range index may represent the direct path component. The range estimation algorithm may also be adaptive to the identified scene. For example, if scene classification 535 indicates an indoor scene, the range estimation algorithm may use the current closest peak index to find the range index of a point 1.5 dB down to the left (closer in range) of the candidate peak corresponding to the current closest peak index as the direct path component. In one embodiment, the range estimation algorithm may identify the direct path component as a maximum of the one or more candidate peaks or a 2 dB lower bandwidth peak.

The spectrum generation and range estimation module 580 may output initial range estimates 585 based on the multiple frames of I/Q measurement data and may determine a variance of initial range estimates 585. The variance of initial range estimate 585 may be output as estimation variance 589. As mentioned, feature selection module with adaptive filter 540 may use estimation variance 589 as a measure of the level confidence associated with one or more previous frames of I/Q measurement data to adjust the bandwidth of the confidence-based bandpass filter to process a new frame of I/Q measurement data.

A tracker module 590 may be a Kalman filter that processes initial range estimates 585 from spectrum generation and range estimation module 580 to achieve faster convergence of the range estimates. In one embodiment, the Kalman filter may utilize a constant velocity model or a constant acceleration model to associate and estimate updated range estimates (595). The Kalman filter may output the state covariance matrix as tracker covariance coefficient 593 to represent the uncertainty in the state estimate. As mentioned, tracker covariance coefficient 593 may provide the confidence level feedback for the confidence-based bandpass filter to adjust its bandwidth. For example, feature selection module with adaptive filter 540 may progressively narrow its bandwidth as tracker covariance coefficient 593 from the Kalman filter decreases (level of confidence in the state estimate increases) as a result of more range measurements being at the same target distance.

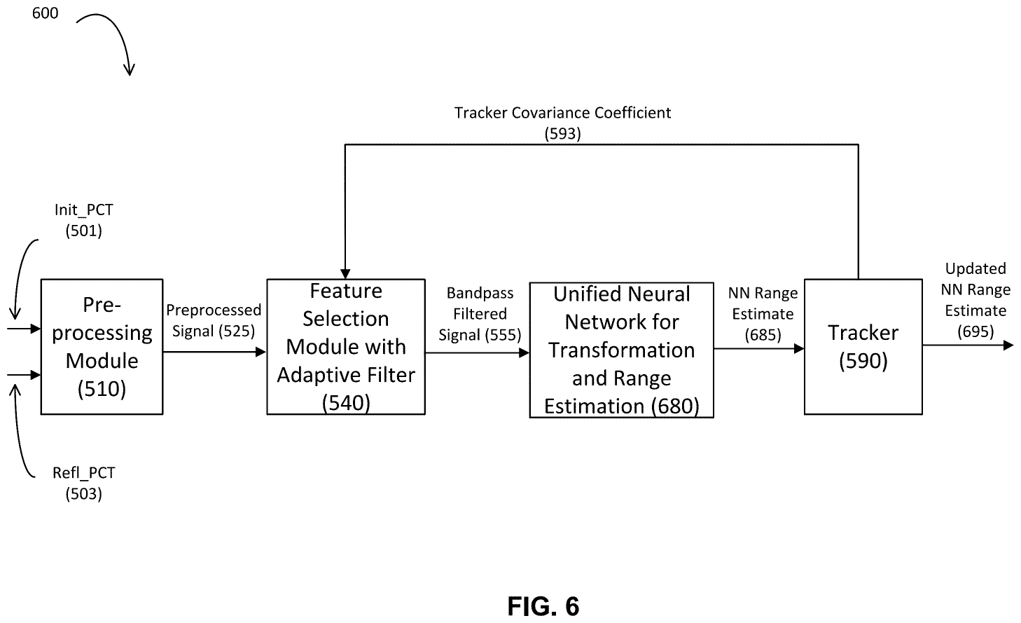

FIG. 6 illustrates a block diagram of a CS processing pipeline 600 with a neural network for feature transformation and range estimation functionality, in accordance with one aspect of the present disclosure. In CS processing pipeline 600, the pre-processing module 510, the feature selection module with adaptive filter 540, and the tracker 590 may be the same as those in the model-based processing pipeline of FIG. 5. However, a unified neural network for feature transformation and range estimation 680 replaces the feature transformation module 560 and the spectrum generation and range estimation module 580 of FIG. 5.

In one embodiment, unified neural network for feature transformation and range estimation 680 (or simply neural network 680) may include fully connected layers to achieve both feature transformation and range estimation. The input to neural network 680 may be complex residual PCT represented by the bandpass filtered signal 555. Neural network 680 may be simultaneously trained with multi-task learning framework to generate a transformed spectrum and range estimates. Training data augmentation may be used including techniques such as noise injection, time-frequency masking, and channel simulation to augment the training data. These techniques increase the diversity of the training data and improve the robustness of the neural network. Consolidating the feature transformation, spectrum generation, and range estimation functionalities into a single parametric neural network enables the CS processing pipeline 600 to generalize across different scenarios and improves robustness in the range estimates.

The parametric data-driven neural network design leverages the strengths of both data-driven and model-based approaches. The neural network model for range estimation in the BLE CS domain combines the strength of deep learning with techniques that retain the interpretable design of traditional model-based pipelines (e.g., DFT-based or MVDR algorithm) leveraging domain knowledge, leading to improved accuracy while reducing computational complexity. However, unlike traditional DFT, where frequencies are fixed and equi-spaced, neural network 680 enables the learned features to discover frequencies that are non-integer, sampled at non-fixed positions, yet in ascending order (e.g., progressively increasing). Neural network 680 may dynamically adjust and refine frequency selection during training. This approach empowers neural network 680 to transcend discrete and fixed frequency steps, embracing more nuanced and granular representations, and ultimately leading to enhanced feature extraction from complex IQ data.

Neural network 680 may also adapt to various environments (e.g., scene types) without requiring an explicit scene identification step, as it learns to find optimal or tuned parameters associated with various environments during training. This adaptability enables the neural network 680 to generalize across different scenarios, making it a more robust and versatile solution for range estimation. For example, neural network 680 may use the tuned parameters associated with an indoor environment when estimating a range between two devices operating indoor. A tracker module 590 may process NN range estimates 685 generated by the neural network 680 to make updated NN range estimates 695. In another embodiment, the neural network model may integrate de-noising or noise-reduction functionality to increase a signal-to-noise ratio (SNR) such as that performed by feature selection module with adaptive filter 540.

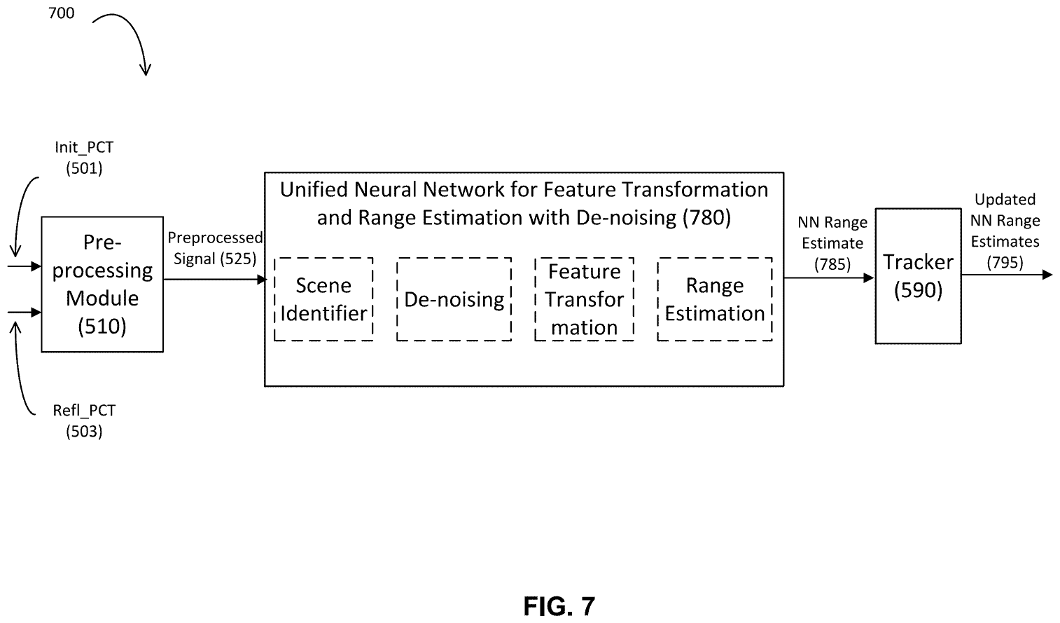

FIG. 7 illustrates a block diagram of a CS processing pipeline 700 with a unified neural network for feature transformation and range estimation with de-noising functionality, in accordance with one aspect of the present disclosure.

A unified neural network for feature transformation and range estimation with de-noising 780 (or simply unified neural network 780) consolidates scene identifier, de-noising, feature transformation, spectrum generation, and range estimation functionalities into a single parametric neural network. As in the neural network 680 of FIG. 6, the unified neural network 780 receives preprocessed signal 525 from pre-processing module 510. The unified neural network 780 may mimic the feature transformation structure with the capability to simultaneously denoise the signal through an auxiliary loss function. The auxiliary loss function minimizes the output spectrum of the feature transformation with the desired range spectrum, utilizing the ground truth range from labeled data.

A main loss function may be calculated as the mean squared error between estimated and true distances. In conjunction with the mean loss function, an auxiliary loss function may compare the estimated spectrum of the complex DFT layer of the unified neural network 780 with an artificially generated spectrum of the environment featuring only a dominant peak. Based on the known distance, ideal IQ characteristics may be generated and processed using IFFT to generate the expected output spectrum during training. The difference between the expected and estimated spectra may be calculated as the mean squared error. The training process may incorporate two hyperparameters, representing the weights of the main and auxiliary losses, enabling a balanced optimization of both objectives.

As in the neural network 680 of FIG. 6, unified neural network 780 may use a parametric feature transformation layer to dynamically adjust and refine frequency selection during training to discover frequencies that are non-integer and progressively increasing, leading to enhanced feature extraction from the complex IQ data. In one embodiment, instead of solely adjusting the granular frequencies, the entire kernel weights of the parametric feature transformation layer may be trained, thereby maintaining the model's computational efficiency while providing additional feature dimensions for unified neural network 780 to learn, resulting in enhanced feature transformation and de-noising signal performance. The unified neural network 780 may estimate the peak or 2 dB lower beamwidth from the peak of the transformed spectrum. A tracker module 590 may process NN range estimates 785 provided by unified neural network 780 to generate updated NN range estimates 795. In one embodiment, a split-model approach may be employed for the neural network design, where a feature extraction layer is common and trained on the entire dataset to extract features across indoor and outdoor environments, and separate sub-models for range estimation based on the extracted features are trained independently for indoor and outdoor environments, respectively.

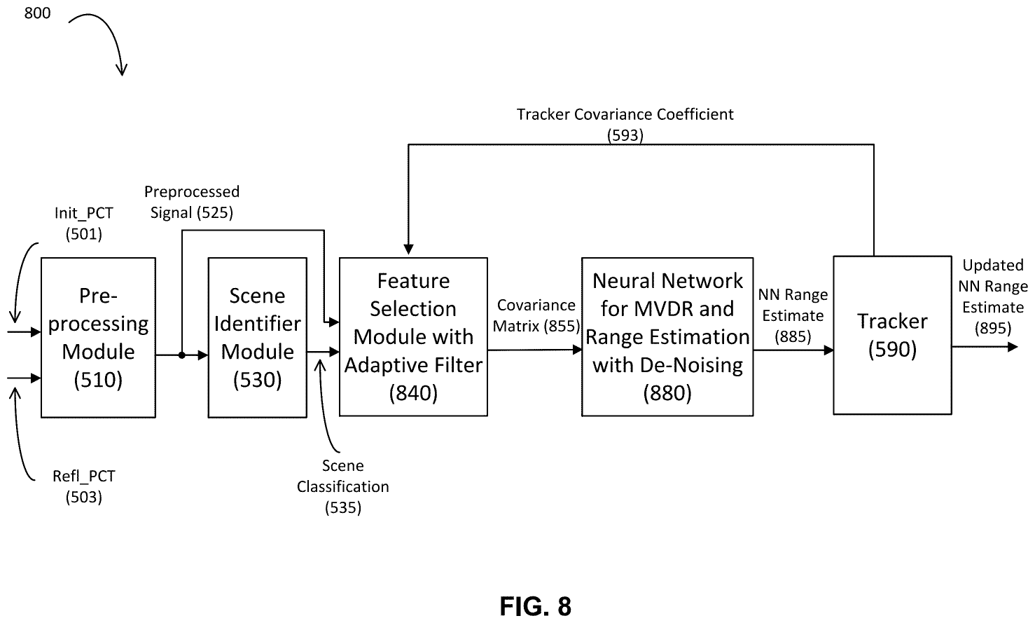

FIG. 8 illustrates a block diagram of a CS processing pipeline 800 including another embodiment of the neural network for feature transformation and range estimation with . . . de-noising functionality, in accordance with one aspect of the present disclosure. A neural network for feature transformation and range estimation with de-noising 880 (or simply neural network 880) may replace MVDR-based feature transformation. As mentioned, MVDR-based techniques may generate a narrower peak in the time domain than IFFT-based techniques, allowing for finer resolution of multipath components to detect the target as the closest peak

As in FIG. 6, a scene identification module 530 may process statistical properties of preprocessed signal 525 from pre-processed module 510 to identify the scene. A feature selection module with adaptive filter 840 may adaptively adjust a bandwidth of a bandpass filter used to filter preprocessed signal 525 based on scene classification 535 from scene identification module 530 and a level of confidence associated with the data points. In one embodiment, the level of confidence may be tracker covariance coefficient 593 provided by a tracker module 590 to represent the uncertainty in the state estimate as in FIG. 6. Feature selection module with adaptive filter 840 may generate a covariance matrix 855 of the bandpass filtered signal across a subset of frequency channels of BLE CS ranging.

Neural network 880 may receive covariance matrix 855 to perform feature transformation and ranges estimates. As in the neural network 680 of FIG. 6 and the unified neural network 780 of FIG. 7, neural network 880 may use a parametric feature transformation layer to dynamically adjust and refine frequency selection during training to discover frequencies that are non-integer and progressively increasing, leading to enhanced feature extraction from the complex IQ data. As in the unified neural network 780 of FIG. 7, an auxiliary loss function may compare the estimated spectrum of neural network 880 with an artificially generated spectrum of the environment featuring only a dominant peak in addition to a main loss function of the mean squared error between estimated and true distances. The tracker module 590 may process NN range estimates 885 provided by neural network 880 to generate updated NN range estimates 895.

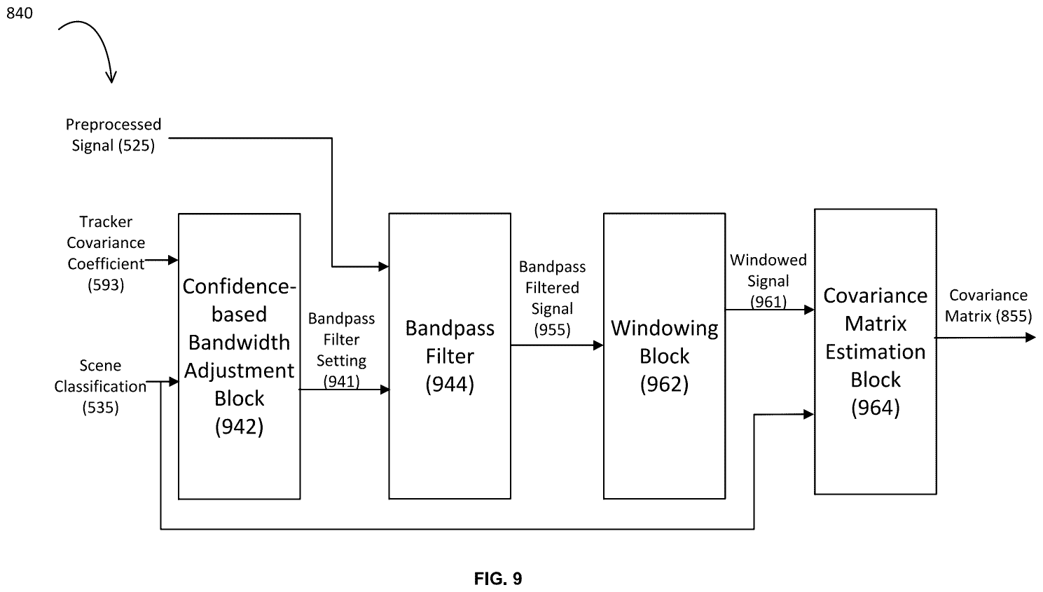

FIG. 9 illustrates a block diagram of an embodiment of the feature selection module with adaptive filter 840 used to adaptively adjust a bandwidth of a confidence-based bandpass filter for filtering the I/Q measurement data based on a confidence level in the data points and the identified scene, and to generate a covariance matrix 855 based on the bandpass-filtered I/Q data in accordance with one aspect of the present disclosure.

A confidence-based bandwidth adjustment block 942 may adjust the bandwidth of a bandpass filter 944 based on tracker covariance coefficient 593 received from a tracker module such as a Kalman filter when scene classification 535 indicates an indoor scene. The tracker covariance coefficient 593 may represent the uncertainty in the estimate of the Kalman filter based on the data points. In one embodiment, the tracker covariance coefficient 593 may represent the uncertainty in the range estimate determined from one or more previous frames of the PBR measurement data by the Kalman filter. A smaller tracker covariance coefficient 593 indicates higher confidence in the estimate that may be the result of more measurement data giving rise to the same range estimate. Confidence-based bandwidth adjustment block 942 may generate bandpass filter setting 941 to gradually narrow the filter bandwidth (e.g., stop frequencies) of bandpass filter 944 to allow a smaller range of frequency components around the expected signal to pass through. Bandpass filter 944 thus focuses on the most likely signal components and reduces the influence of out-of-band interference, reflections, or noise on the data points. Bandpass filter 944 may filter preprocessed signal 525 of a current frame of the PBR measurement data based on bandpass filter setting 941 to generate bandpass filtered signal 955.

On the other hand, a larger tracker covariance coefficient 593 indicates less confidence in the estimate from the tracker module and may result from a potential change in the true signal, for example when a tracked device moved. Confidence-based bandwidth adjustment block 942 may generate bandpass filter setting 941 to widen the filter bandwidth of bandpass filter 944. The broader frequency range allows bandpass filter 944 to capture potentially changing signal and to mitigate the influence of potentially unreliable data.

A windowing block 962 may apply a window function to bandpass filtered signal 955 to generate windowed signal 961 to reduce spectral leakage such as to eliminate sidelobes. A covariance matrix estimation block 964 may construct the covariance matrix 855 of windowed signal 961 across a number of frequency channels of BLE CS ranging. In one embodiment, covariance matrix 855 may be both temporally smoothed and spatially smoothed. Neural network 880 may process covariance matrix 855 to mimic feature transformation and range estimates of MVDR-based techniques to generate NN range estimate 885.

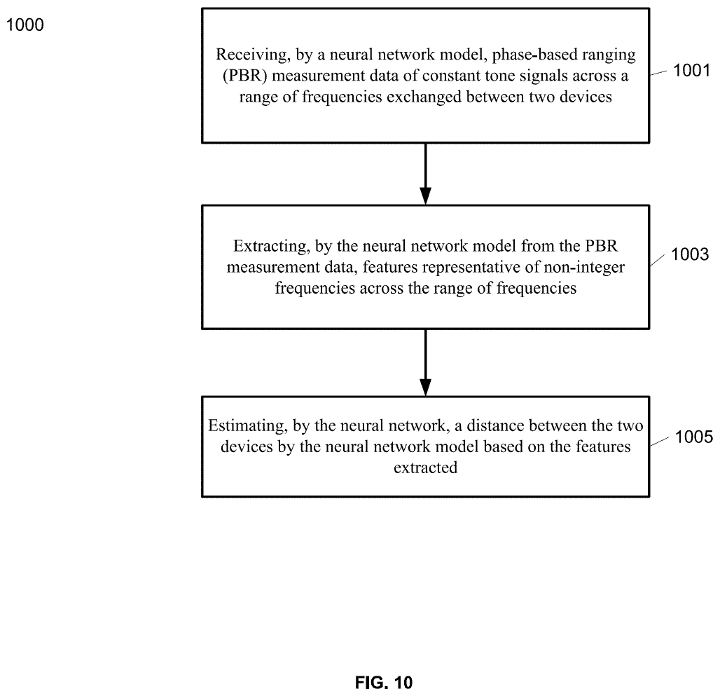

FIG. 10 illustrates a flow diagram of a method 1000 of applying a neural network to phase-based ranging measurement data to perform feature transformation and range estimation of a distance between two devices, in accordance with one aspect of the present disclosure. In one aspect, method 1000 may be performed by an initiator such as CS initiator 210 of FIG. 2 utilizing hardware, software, or combinations of hardware and software.

In operation 1001, a neural network model of an initiator device may receive phase-based ranging (PBR) measurement data of constant tone signals across a range of frequencies exchanged between two devices, such as between the initiator device and a responder device. For example, the initiator device and the responder device may exchange constant tone signals on N channel frequencies of a BLE bandwidth using N respective time slots. During each time slot, the initiator device may transmit a CT signal to the reflector device on a corresponding channel frequency for the reflector device to perform phase (or I/Q) measurement on the received CT signal. Subsequently, the reflector device may transmit back a CT signal to the initiator device on the same channel frequency for the initiator device to perform its phase measurement. At the end of the ranging cycle following the N timeslots for CT exchanges, the reflector device my transmit its measured phase data to the initiator device for the neural network model to process the phase data measured by the responder device as well as the phase data measured by the initiator device.

In operation 1003, the neural network model may extract from the PBR measurement data, features representative of non-integer frequencies across the range of frequencies. The neural network model may be trained with a multi-task learning framework to simultaneously generate a clean spectrum and a range estimate. Unlike DFT-based techniques, where frequencies are fixed and equi-spaced, the learned features of the neural network may discover frequencies that are non-integer, sampled at non-fixed positions, and in an ascending order to enhance feature extraction from the PBR measurement data. In one embodiment, the neural network model combines scene identification, de-noising, feature transformation and range estimation steps into a single neural network model. By combining these steps into a single neural network model, the neural network model may adapt to various scene types or environments without requiring an explicit scene identification step.

In operation 1005, the neural network model may estimate a distance between the two devices based on the features extracted. In one embodiment, the neural network model may estimate a distance in various scene types or environments (e.g., indoor, outdoor, etc.) without requiring an explicit scene identification step. In one embodiment, the neural network model may employ an auxiliary loss function in conjunction with a main loss function during training to estimate a distance. The main loss function may be calculated as the mean squared error between estimated and true distances. The auxiliary loss function may compare the estimated spectrum of a feature transformation layer of the neural network model with an artificially generated spectrum of the environment featuring only a dominant peak. The auxiliary loss function may be calculated as the mean squared error between the expected and estimated spectra. The trained neural network model may incorporate the two hyperparameters representing the weights of the main and auxiliary losses.

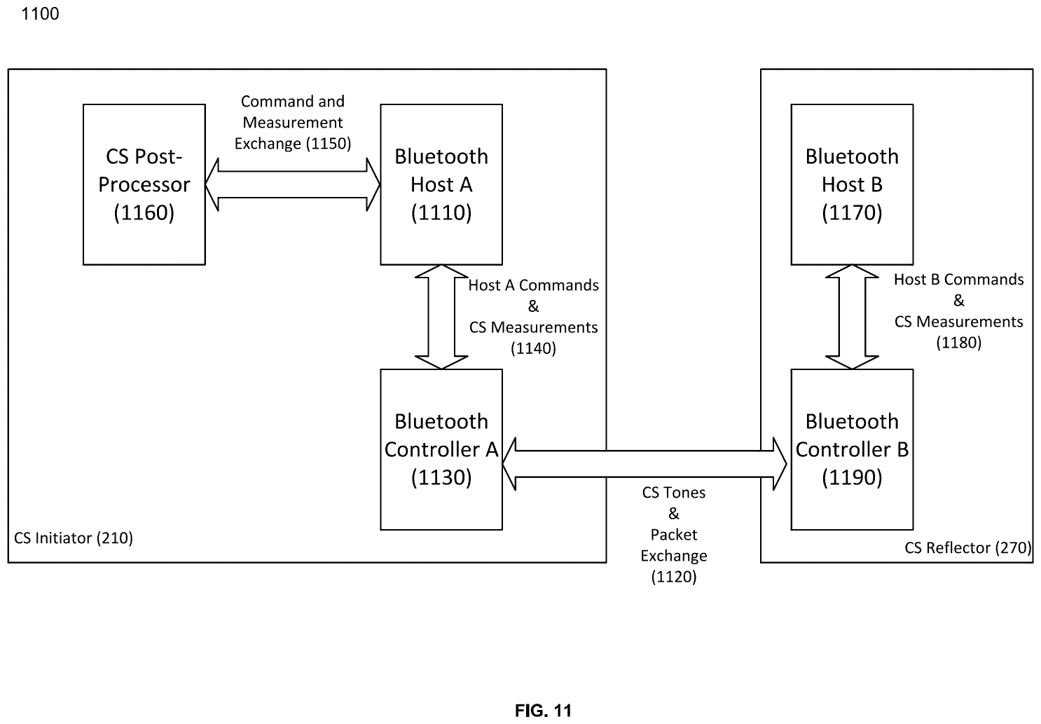

FIG. 11 illustrates a functional block diagram 1100 of two Bluetooth devices 210 and 270 that implement phase-based ranging using (CS and CS post-processing of the phase measurement data to estimate a range between the two devices using a neural network model, in accordance with one aspect of the present disclosure.

A CS initiator 210 may have a Bluetooth controller A 1130, a Bluetooth host A 1110, and a CS post-processor 1160. A CS reflector 270 may have a Bluetooth controller B 1190 and a Bluetooth host B 1170. Bluetooth controller A 1130 and Bluetooth controller B 1190 may exchange constant tones and packets on multiple channel frequencies 1120 in a ranging cycle using a channel shuffling mechanism. In one embodiment, the two device may exchange 72 constant tone signals across the 80 MHz of the entire 2.4 GHz ISM band in BLE to determine a wideband frequency transfer function of the channel. Bluetooth controller B 1190 may transmit its measured phase of the received constant tone signals to Bluetooth controller A 1130.

Bluetooth controller A 1130 may receive host commands from Bluetooth host A 1110 through host A commands & CS measurements interface 1140 to perform the operations of the ranging cycle. Similarly, Bluetooth controller B 1190 may receive host commands from Bluetooth host B 1170 through host B commands & CS measurements interface interface 1180 to perform the ranging cycle operations. Bluetooth controller B 1190 may transmit its phase measurements to its Bluetooth host B 1170 through host B commands & CS measurements interface interface 1180 for processing such as during the calibration-synchronization timeslot. Bluetooth controller A 1130 may transmit its phase measurements and the phase measurements received from Bluetooth controller B 1190 to Bluetooth host A 1110 through host A commands & CS measurements interface 1140 for processing. Bluetooth host A 1110 may process the phase measurements exchanged during the ranging cycle to estimate the range or may invoke CS post-processor 1160 to process the phase measurements through command and measurement exchange interface 1150. Bluetooth host A 1110 or CS post-processor 1160 may process the phase measurements as described for operations of FIGS. 6-10 based on a neural network model utilizing hardware, software, or combinations of hardware and software.

Various embodiments of the multi-carrier phase-based ranging system described herein may include various operations. These operations may be performed and/or controlled by hardware components, digital hardware and/or firmware/programmable registers (e.g., as implemented in computer-readable medium), and/or combinations thereof. For example, the operations may be performed by a general-purpose computer or a processing system executing computer program stored in a computer-readable medium. The methods and illustrative examples described herein are not inherently related to any particular device or other apparatus. Various systems (e.g., such as a wireless device operating in a near or long field environment, pico area network, wide area network, etc.) may be used in accordance with the teachings described herein, or it may prove convenient to construct more specialized apparatus to perform the required method steps. The required structure for a variety of these systems will appear as set forth in the description above.

A computer-readable medium used to implement operations of various aspects of the disclosure may be non-transitory computer-readable storage medium that may include, but is not limited to, electromagnetic storage medium, magneto-optical storage medium, read-only memory (ROM), random-access memory (RAM), erasable programmable memory (e.g., EPROM and EEPROM), flash memory, or another now-known or later-developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A computer-implemented method for measuring a distance between two devices, comprising:
receiving phase-based ranging (PBR) measurement data of constant tone signals across a range of frequencies exchanged between the two devices;
applying a neural network model to the PBR measurement data to extract features representative of non-integer frequencies across the range of frequencies; and
estimating a distance between the two devices by the neural network model based on the features extracted.

2. The method of claim 1, wherein the neural network model is trained to estimate the distance when the PBR measurements are obtained from constant tone signals exchanged between the two devices operating under a plurality of indoor and outdoor environments.

3. The method of claim 1, wherein applying the neural network model to the PBR measurement data to extract features comprises:
processing the PBR measurement data in a frequency domain representation to extract features representative of non-integer frequencies that are progressively increasing and sampled at non-fixed positions.

4. The method of claim 1, wherein applying the neural network model to the PBR measurement data to extract features comprises:
reducing noise in the PBR measurement data by the neural network model to increase a signal-to-noise ratio (SNR).

5. The method of claim 1, wherein applying the neural network model to the PBR measurement data to extract features comprises:
identifying parameters associated with a plurality of indoor and outdoor environments to aid in estimating the distance between the two devices.

6. The method of claim 1, further comprising:
training the neural network model based on an auxiliary loss function, wherein the auxiliary loss function comprises a difference between an expected spectrum featuring a dominant peak representing a known distance between the two devices and an estimated spectrum generated by the neural network model.

7. The method of claim 6, further comprising:
training the neural network model based on a main loss function, wherein the main loss function comprises a difference between an expected distance between the two devices and an estimated distance generated by the neural network model.

8. The method of claim 1, further comprising:
processing a current frame of the PBR measurement data to reduce errors introduced when the two devices exchange the constant tone signals to generate pre-processed data;
filtering the pre-processed data using an adaptive bandpass filter to generate bandpass filtered signal, wherein a filter setting of the adaptive bandpass filter is adjusted based on a confidence level in a distance estimate determined from a previous frame of the PBR measurement data; and
applying the neural network model to the bandpass filtered signal.

9. The method of claim 8, wherein filtering the pre-processed data further comprises:
generating a covariance matrix of the bandpass filtered signal across a subset of the range of frequencies based on an identification of a type of environment existing between the two devices,
and wherein applying a neural network model to the PBR measurement data comprises:
processing the covariance matrix of the bandpass filtered signal to extract the features to mimic a feature transformation performed by a minimum variance distortion-less response (MVDR) algorithm.

10. The method of claim 1, wherein the neural network model comprises:
a common feature extraction layer trained to extract the features across an indoor environment and an outdoor environment; and
separate models trained to estimate the distance between the two devices based on the features extracted for the indoor environment and the outdoor environment.

11. An apparatus comprising:
a processing system configured to:
receive phase-based ranging (PBR) measurement data of constant tone signals across a range of frequencies exchanged between two devices;
apply a neural network model to the PBR measurement data to extract features representative of non-integer frequencies across the range of frequencies; and
apply the neural network model to estimate a distance between the two devices based on the features extracted.

12. The apparatus of claim 11, wherein the neural network model is trained to estimate the distance when the PBR measurements are obtained from constant tone signals exchanged between the two devices operating under a plurality of indoor and outdoor environments.

13. The apparatus of claim 11, wherein to apply the neural network model to the PBR measurement data to extract features, the processing system is configured to:
process the PBR measurement data in a frequency domain representation to extract features representative of non-integer frequencies that are progressively increasing and sampled at non-fixed positions.

14. The apparatus of claim 11, wherein to apply the neural network model to the PBR measurement data to extract features, the processing system is configured to:
reduce noise in the PBR measurement data by the neural network model to increase a signal-to-noise ratio (SNR).

15. The apparatus of claim 11, wherein to apply the neural network model to the PBR measurement data to extract features, the processing system is configured to:
identify parameters associated with a plurality of indoor and outdoor environments to aid in estimating the distance between the two devices.

16. The apparatus of claim 11, wherein the processing systems is further configured to:
train the neural network model based on an auxiliary loss function, wherein the auxiliary loss function comprises a difference between an expected spectrum featuring a dominant peak representing a known distance between the two devices and an estimated spectrum generated by the neural network model.

17. The apparatus of claim 11, wherein the processing systems is further configured to:
process a current frame of the PBR measurement data to reduce errors introduced when the two devices exchange the constant tone signals to generate pre-processed data;
filter the pre-processed data using an adaptive bandpass filter to generate bandpass filtered signal, wherein a filter setting of the adaptive bandpass filter is adjusted based on a confidence level in a distance estimate determined from a previous frame of the PBR measurement data; and
apply the neural network model to the bandpass filtered signal.

18. The apparatus of claim 17, wherein to filter the pre-processed data, the processing system is configured to:
generate a covariance matrix of the bandpass filtered signal across a subset of the range of frequencies based on an identification of a type of environment existing between the two devices,
and wherein to apply a neural network model to the PBR measurement data, the processing system is configured to:
process the covariance matrix of the bandpass filtered signal to extract the features to mimic a feature transformation performed by a minimum variance distortion-less response (MVDR) algorithm.

19. The apparatus of claim 11, wherein the neural network model comprises:
a common feature extraction layer trained to extract the features across an indoor environment and an outdoor environment; and
separate models trained to estimate the distance between the two devices based on the features extracted for the indoor environment and the outdoor environment.

20. A system comprising:
a host device;
an initiator device configured to exchange constant tone signals with a reflector device in phase-based ranging (PBR) to obtain measurement data; and
a processing system configured to:
apply a neural network model to the measurement data to extract features representative of non-integer frequencies across the range of frequencies; and
apply the neural network model to estimate a distance between the initiator device and the reflector device based on the features extracted.
